(19) United States
(12) Patent Application Publication
(10) Pub. No.: US 2022/0412375 A1
(43) Pub. Date: Dec. 29, 2022

(54) FILTERED FAN APPARATUS

(71) Applicant: Ice Qube, Inc., Greensburg, PA (US)

(72) Inventors: Ridge Altman, Greensburg, PA (US); Destin Altman, Greensburg, PA (US)

(73) Assignee: Ice Qube, Inc., Greensburg, PA (US)

(21) Appl. No.: 17/850,576

(22) Filed: Jun. 27, 2022

Related U.S. Application Data
(60) Provisional application No. 63/242,119, filed on Sep. 9, 2021.
(60) Provisional application No. 63/215,149, filed on Jun. 25, 2021.

(51) Int. Cl. F04D 29/70; F04D 29/40

(52) U.S. Cl. CPC F04D 29/703; F04D 29/403

(57) ABSTRACT

The subject matter relates to filtered fan hoods and related systems. In one example, a filtered fan hood is provided. The filtered fan hood includes a housing including at least an ambient side and two lateral sides having opposing faces; and a series of staggered baffles secured about the opposing faces such that each baffle in the series of staggered baffles is seated against, alternately, an enclosure side and an ambient side of the housing; whereby an airflow circuit is established by the series of staggered baffles.

### CROSS-REFERENCE TO RELATED APPLICATIONS

This application claims priority to U.S. provisional patent application ser. Nos. 63/215,149 and 63/242,119, each having the same title and filed on 25 Jun. 2021 and 9 Sep. 2021, respectively. The contents of each foregoing U.S. provisional patent application are incorporated by reference herein.

### BACKGROUND

Industry and manufacturing have emerged with the widespread use of enclosures for a variety of items, for example electronics or other items that require protection from the elements as well as cooling. To protect these items from harsh environments, they are typically placed in sealed enclosures or workstations that permit efficient operation without the threat of being exposed to exterior contaminates including dust, residue, rain, and liquids that have the potential to cause serious damage. Since the items (such as electronics used in the telecommunications industry or like equipment) often generate heat within the enclosure, various cooling equipment such as air conditioners, heat exchangers, in-line compressed air coolers and filtered fan systems are used to maintain required operating temperatures within the enclosure. In some cases, such cooling equipment may be provided as an addition to the enclosure, e.g., a cooling system may be provided separately and attached to an enclosure.

### SUMMARY

In summary, one embodiment provides a filtered fan hood, comprising: a housing including at least an ambient side and two lateral sides having opposing faces; and a series of staggered baffles secured about the opposing faces such that each baffle in the series of staggered baffles is seated against, alternately, an enclosure side and an ambient side of the housing; whereby an airflow circuit is established by the series of staggered baffles.

In an embodiment, the series of staggered baffles comprise at least three baffles. One or more baffles of the series of staggered baffles is removable. One or more baffles of the series of staggered baffles is angled, e.g., is angled at about 16 degrees with respect to horizontal. In an embodiment, the filtered fan hood comprises a lower baffle. The lower baffle may be integral to the housing.

In an embodiment, the filtered fan hood comprises a filter tray. The filter tray comprises one or more of a bracket, a filter holder, a clip and a filter.

An embodiment provides systems, e.g., including two or more filtered fan hoods, an enclosure, and combinations thereof. An embodiment provides a method of assembling and/or configuring a modular filtered fan hood, e.g., adding or removing a filter or filter tray, inserting, removing, or angling one or more baffles, and the like.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

FIG. 1 illustrates a cross-sectional view of an example filtered fan system mounted on an enclosure.

FIG. 2 illustrates an example filtered fan apparatus.

FIG. 3 illustrates an exploded view of the example filtered fan apparatus.

FIG. 4(A-B) illustrates an example tray assembly and exploded view thereof for use in connection with a filtered fan apparatus.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “in an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, etc. In other instances, well-known structures, materials, or operations are not shown or described in detail to avoid obfuscation.

Certain cooling systems often treat the enclosed air only, while sealing out the potential contaminated ambient environment. In cases where the ambient air is near room temperature (70-85 degrees Fahrenheit) and when there is not a threat of rain or splashing liquids present outside the enclosure, a filtered fan system is used to maintain a constant flow of filtered ambient air through the enclosure. These systems typically are less costly than closed-looped systems and simply employ a fan which induces the cooler ambient air through a filter media into the enclosure, therefore creating a positive pressure inside the enclosure forcing the hot enclosure air out through an exhaust vent.

In addition, certain filtered fan systems have been developed in an attempt to provide added protection for the contents of the enclosure. For example, filtered fan systems that include baffles or filters, or a combination thereof, have been developed that offer some protection from the intrusion of elements, such as water, into the enclosure.

An embodiment provides a filtered fan hood with additional features such as a series of angled baffles and/or a filter tray insert, e.g., to make it compliant with certain standards, such as NEMA 4X (National Electrical Manufacturers Association). Other embodiments are described herein.

The description now turns to the figures, which illustrate certain example embodiments.

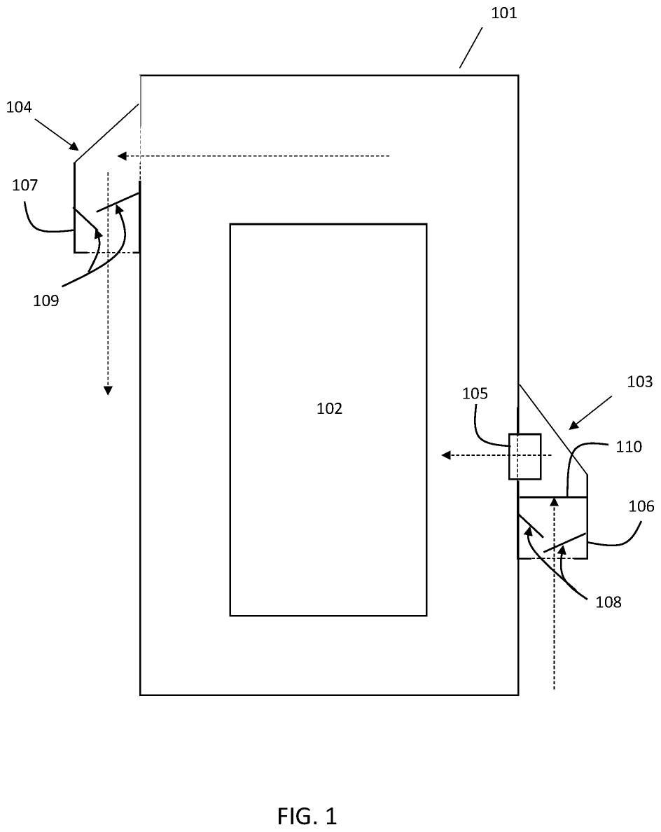

FIG. 1 illustrates a cross-sectional side view of wash down filtered fans 103, 104 in combination with an enclosure 101 enclosing items 102 for protection from detrimental external elements. In an embodiment, the enclosure 101 may be a sealed enclosure and items 102 may include telecommunications equipment. Conventionally, an enclosure 101 is supported above a surface by support feet (not illustrated). By way of example, items 102 such as electronics, electromechanical equipment, computers or other sensitive electronic systems (hereinafter collectively referred to as “electronics”) are often housed in enclosure 101 requiring particular care with respect to harsh industrial environments, spray from water hoses used in washing operations, and outside weather conditions. Thus, residues, rain, snow and other liquids are a constant threat to items 102 such as computers and other sophisticated electronics. A wash down filtered fan apparatus or system in the example of FIG. 1 includes two parts, i.e., an intake 103 and an exhaust 104. Intake 103 and exhaust 104 effectively prevent any threat of water, spray, rain and/or direct pressurized water spray that may be sprayed into an intake inlet or an exhaust outlet. Intake 103 and exhaust 104 may comprise a housing constructed from a variety of materials, with stainless steel being one example.

As is shown in FIG. 1, an intake 103 is secured to the enclosure 101, for example via a plurality of nuts and bolts (not illustrated), at a first vertical surface of the enclosure 101. The intake 103 has a downwardly oriented intake inlet opening and an outlet opening that allows air to pass over air permeable filter 110 (which may be included in one or more of the intake 103 and exhaust 104) and into the enclosure 101, as illustrated with dashed arrows in FIG. 1. In an embodiment, one or more baffles 108 may be located upward from the intake opening and below a blower assembly 105 that is secured within intake 103. In a similar fashion, one or more baffles 109 may be included in exhaust 104. The blower assembly 105 includes a fan, an impeller, or like element for inducing ambient air into intake 103 and into the enclosure 101, circulating around heat generating items 102 such as electronics for cooling purposes.

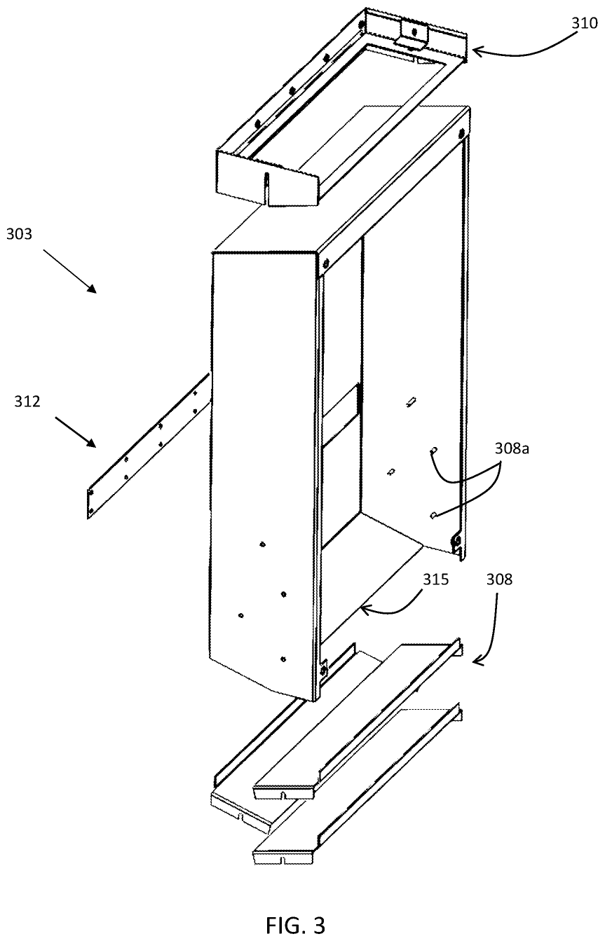

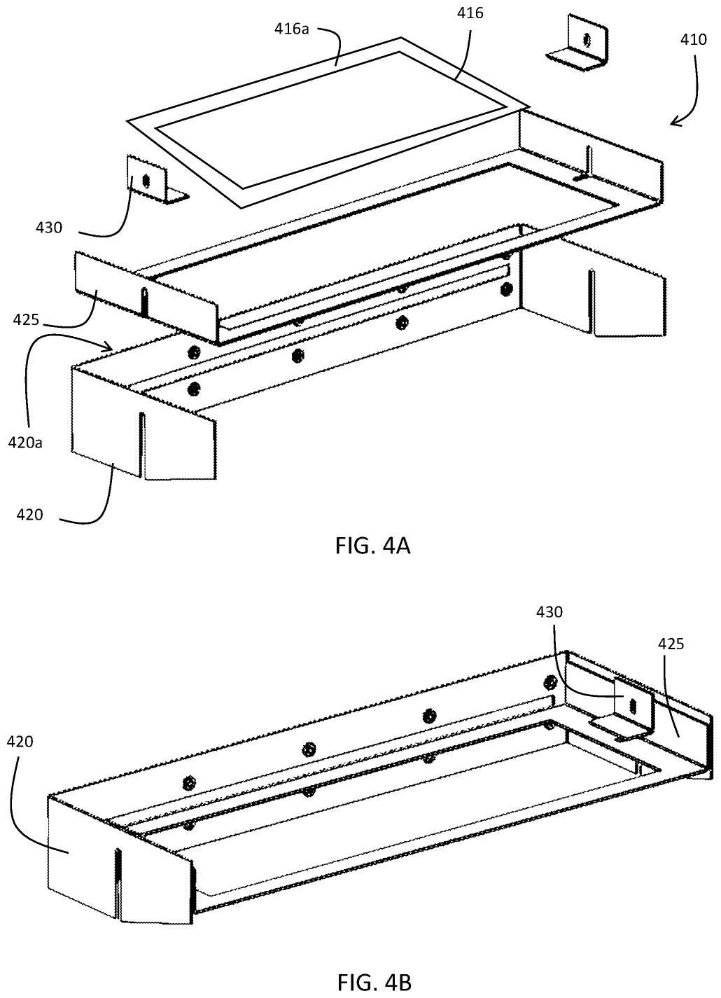

An air permeable filter 110 shown in intake 103 is removably secured to a tray, as for example illustrated in FIG. 4(A-B). In one example, a hinged mechanism may be provided for permeable air filter 110, e.g., for access and removal from below. The air permeable filter 110 functions to screen out undesirable air borne particulate from entrance into enclosure 101. Air permeable filter 110 may be inserted and removed to and from the bottom of the intake 103 or via a cut out (as illustrated in FIG. 3) for easy cleaning and replacement of air permeable filter 108.

Further illustrated in FIG. 1 is an exhaust 104, which may include the same or different components when compared to the intake 103. In the example illustrated in FIG. 1, the exhaust 104 includes all of the components of the intake 103 except the blower assembly 105 and permeable filter 110. Therefore, exhaust 104 likewise includes an air inlet and outlet for channeling heated air from the inside of the enclosure 101 to ambient, as illustrated with dashed arrows in FIG. 1. The example exhaust 104 of FIG. 1 includes baffles 109, again positioned near or proximate to the bottom of the exhaust 104.

In FIG. 1, a lower part 106 of the intake 103 and a lower part 107 of the exhaust 104 are indicated. The lower parts 106, 107 may be integral to intake 103 and exhaust 104, respectively. In an embodiment, intake 103 or exhaust 104 may be formed of two major components, where the lower parts 106, 107 are separate from upper parts of the intake 103 and exhaust 104. Therefore, in certain embodiments, the lower parts 106, 107 may take the form of an extension part that can be added to an existing filtered fan intake or exhaust, e.g., for improving their performance with respect to intrusion of unwanted elements such as water. For example, the lower parts 106, 107 may be attached to an existing NEMA 3R hood to make it a NEMA 4/4X hood.

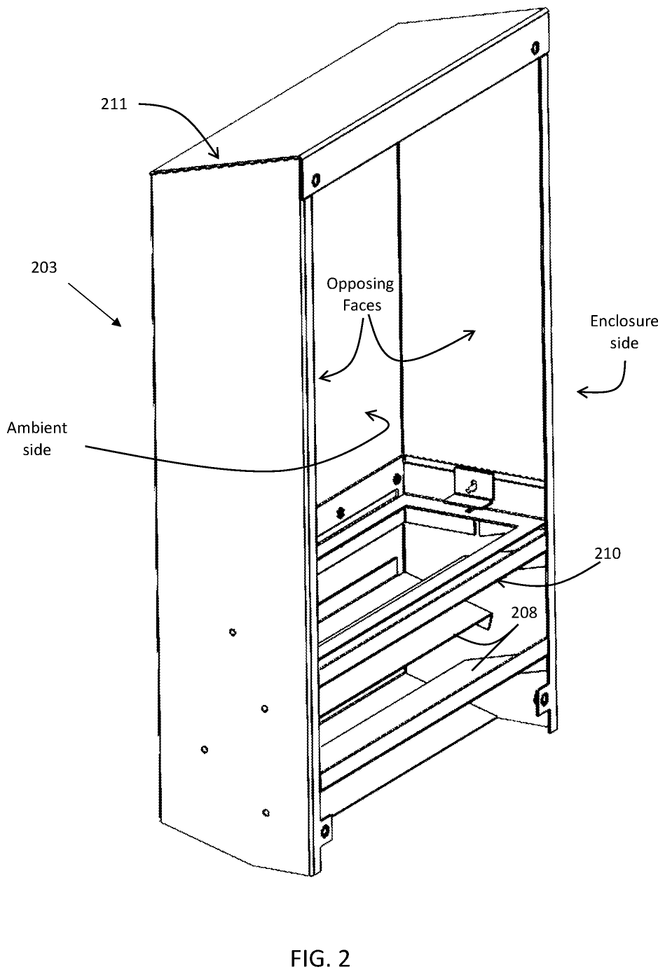

In FIG. 2 an example intake 203 is illustrated, with the back or enclosure facing side (where a physical enclosure side of the intake 203 may or may not be included) turned towards the viewer of FIG. 2. In this example, a series of downwardly angled baffles 208 are visible. The baffles 208 are situated below a filter tray 210 that holds an air permeable filter therein (filter not illustrated in FIG. 2). In one example, intake 103 is about 14 inches wide, about 19 inches long and about 5 inches deep. In an embodiment, the upper and/or lower parts of the intake 103 are angled such that a roof or top element 211 conducts water down and away from the enclosure. In one example, the angle is about 16 degrees. This same angle or a different angle may be used for one or more baffles 208. In an embodiment, the angle is adjustable or configurable, e.g., via inclusion of different mounting studs 308a (refer to FIG. 3).

In an embodiment, one or more of the baffles 208 may be provided in a series arrangement as shown in FIG. 2 such that each baffle 208 in the series is staggered or alternately seated against an ambient side of the housing or an enclosure side of the housing (or enclosure is no enclosure side of the housing is provided). This facilitates a circuitous pathway (airflow circuit) that air may easily flow through, but water or other undesirable environmental components find difficult to traverse. In one example embodiment, the baffles are also angled. In one example, the angle may be about 16 degrees downward, similar to that of an upper part 211 of the housing.

As illustrated in the exploded view of FIG. 3, one or more components or parts of the intake 303 may be modular. In the example illustrated, the baffles 308 may be removed, e.g., removed from mounting studs 308a to accommodate more or fewer baffles used in the intake 303. The tray assembly 310 may be removed, e.g., taken out through slot covered by strip 312 for air filter removal or cleaning. In one example, a lower baffle 315 may be included as an integral component, e.g., not removable. For example, the housing material used to make intake 103 may be aluminum, where a sheet of aluminum is folded over to form lower baffle 315. Thus, lower baffle 315 may form part of the housing of the intake 303.

Turning to FIG. 4(A-B), a filter tray assembly 410 is illustrated. In the exploded view of FIG. 4A, the filter tray assembly 410 includes a bracket 420 and filter holder 425 that secure a filter 416 in place using clips 430. As shown in the assembled view of FIG. 4B, the clips 430, filter holder 425 and bracket 420 are assembled together to secure filter 415. The entire filter tray assembly 410 may be inserted to and removed from a slot in the housing, e.g., of intake 303. In one example, strip 312 forms a back portion of bracket 420. For example, bracket 420 may be inserted into a slot in the intake 103 and secured into place to seat the filter therein. In another example, strip 312 covers slot and is not secured to (and does not form part of) bracket 420, rather strip 312 is removable separately from bracket 420 and/or filter 416.

In an embodiment, brackets such as clips 430 may be used to compress filter 416 to help better maintain filter in a sealing arrangement compliant with a standard such as IP66/Type 4/4x. Two or more brackets or clips 430 may be used to compress the filter 416 edges at regular, e.g., predetermined, intervals. In one example embodiment, the filter 416 may comprise a filter material that is electrostatically charged and/or hydrophobic. In one example, a gasket 416a (which may or may not be integral to filter 416) may be formed around (e.g., an upper and lower margin of) filter 416 to seal the filter 416 at the edges thereof, e.g., in a sealing arrangement compliant with a standard such as IP66/Type 4/4x to meet UL50/50E third edition for type 4/4x.

In one example, bracket 420 may include a backplate 420a that is stiffened or strengthened via a material or processing step, for example by imparting bends, folds and/or rolled stamped beads. In another embodiment, strip 312 may be similarly strengthened.

For each of the permeable filters 108, 109, an appropriate filter material may be selected. In an embodiment, a MERV 6 (minimum efficiency reporting value) filter may be used, e.g., as filter 416, which prohibits water from entry into an enclosure 101, even with a direct spray into the filter from a hose. Use of such a filter material in the filter 416 imparts substantial protection from intrusion of unwanted elements such as water, e.g., achieving a NEMA 4 or NEMA 4x rating. A lower flow filter such as a MERV 6 offers the highest protection against water and dust intrusion. In another embodiment, a different filter material may be used, such as a 4-micron filter used as filter 416. In another embodiment a 10-micron filter may be used as filter 416. With increased pore size of the filter material, the filter 416 offers greater air flow but reduced protection from intrusion of water and air borne particles.

The illustrated embodiments are examples of an extended or elongated a housing of a filtered fan configured to achieve compliance with a standard, e.g., NEMA 4X. In an embodiment, a housing 103, 104 is provided as a filtered fan hood for an enclosure 101. The filtered fan system is extended or elongated in comparison to conventional hoods with respect to its bottom, near the intake, elongating or extending the housing of the hood to provide increased distance between the inlet and the enclosure air intake or opening. In the examples illustrated, the numeric measurements are examples provided in inches. In certain embodiments, different sizes of part(s) may be provided to accommodate fitting to different units. In examples where the term “about” (or similar term) is used, these measurements or units include at least numbers obtained via ordinary rounding.

In an embodiment a baffle 108, 109, which may be removable, may be inserted into the housing or otherwise attached or adhered to the housing. A baffle 108, 109 may include studs 308a or mounting elements that insert into corresponding holes in a housing. Alternatively or additionally, a baffle 108, 109 may include grooves or holes that cooperate with studs (308a of FIG. 3) or mounting elements provided on the housing. In certain embodiments, one type of baffle 108, 109 includes one type of mounting element or arrangement, whereas in another baffle 108, 109, a second type of mounting or arrangement is utilized.

In an embodiment, more than one type of baffle 108, 109, cover or insert may be utilized. By way of example, illustrated in FIG. 3 is a lower cover or baffle 315 that attaches to the housing or is formed as an integral part thereof at a lower end and provides a partial, angled cover to the lower margin of the housing. This for example prevents splashed liquids from entering the lower part of the housing but allows airflow there-through.

FIG. 1 illustrates an example of a filtered fan system where it can be appreciated that the rear, enclosure side of the filtered fan intake 103 and/or exhaust 104 (refer to FIG. 2) attaches to the enclosure and provides an opening, i.e., to permit airflow to the enclosure. In an embodiment, the intake 103 and/or exhaust 104 may be secured to the enclosure 101 using various mechanisms, e.g., mounting studs or attachment mechanisms may protrude from the intake 103, permitting fitting thereof onto the enclosure 101.

It is worth noting that while specific elements are illustrated in the figures, and a particular ordering or organization of elements or steps has been illustrated, these are non-limiting examples. In certain contexts, two or more elements or steps may be combined into an equivalent element or step, an element or step may be split into two or more equivalent elements or steps, or certain elements or steps may be re-ordered or re-organized or omitted as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected by one skilled in the art without departing from the scope or spirit of the disclosure.

What is claimed is:

1. A filtered fan hood, comprising:
a housing including at least an ambient side and two lateral sides having opposing faces; and
a series of staggered baffles secured about the opposing faces such that each baffle in the series of staggered baffles is seated against, alternately, an enclosure side and an ambient side of the housing;
whereby an airflow circuit is established by the series of staggered baffles.

2. The filtered fan hood of claim 1, wherein the series of staggered baffles comprise at least three baffles.

3. The filtered fan hood of claim 1, wherein one or more baffles of the series of staggered baffles is removable.

4. The filtered fan hood of claim 1, wherein one or more baffles of the series of staggered baffles is angled.

5. The filtered fan hood of claim 4, wherein one or more baffles of the series of staggered baffles is angled at about 16 degrees with respect to horizontal.

6. The filtered fan hood of claim 1, comprising a lower baffle.

7. The filtered fan hood of claim 6, wherein the lower baffle is integral to the housing.

8. The filtered fan hood of claim 1, comprising a filter tray.

9. The filtered fan hood of claim 8, wherein the filter tray comprises one or more of a bracket, a filter holder, a clip and a filter.

10. A system, comprising:
two or more filtered fan hoods, each comprising:
a housing including at least an ambient side and two lateral sides having opposing faces; and
a series of staggered baffles secured about the opposing faces such that each baffle in the series of staggered baffles is seated against, alternately, an enclosure side and an ambient side of the housing;
whereby an airflow circuit is established by the series of staggered baffles.

11. The system claim 10, wherein the series of staggered baffles comprise at least three baffles.

12. The system of claim 10, wherein one or more baffles of the series of staggered baffles is removable.

13. The system of claim 10, wherein one or more baffles of the series of staggered baffles is angled.

14. The system of claim 13, wherein one or more baffles of the series of staggered baffles is angled at about 16 degrees with respect to horizontal.

15. The system of claim 10, comprising a lower baffle.

16. The system of claim 15, wherein the lower baffle is integral to the housing.

17. The system of claim 10, comprising a filter tray.

18. The system of claim 17, wherein the filter tray comprises one or more of a bracket, a filter holder, a clip and a filter.

19. The system of claim 17, wherein the filter comprises an air permeable filter material.

20. A system, comprising:
an enclosure; and
a filtered fan hood configured to attach to the enclosure, the filter fan hood comprising:
a housing including at least an ambient side and two lateral sides having opposing faces; and
a series of staggered baffles secured about the opposing faces such that each baffle in the series of staggered baffles is seated against, alternately, an enclosure side and an ambient side of the housing;
whereby an airflow circuit is established by the series of staggered baffles.
